(19) United States
(12) Patent Application Publication
(10) Pub. No.: US 2009/0144410 A1
(43) Pub. Date: Jun. 4, 2009

(54) MONITORING NETWORK TRAFFIC BY TRACKING DATA PACKETS ON A PER PROCESS BASIS

(76) Inventors: Glenn A. Fink, Richland, WA (US); Brandon J. Carpenter, Kennewick, WA (US)

Correspondence Address: BATTELLE MEMORIAL INSTITUTE;ATTN: IP SERVICES, K1-53, P. O. BOX 999, RICHLAND, WA, 99352, US

(21) Appl. No.: 11/948,415

(22) Filed: Nov. 30, 2007

(51) Int. Cl. G06F 15/173; G06F 15/177

(52) U.S. Cl. 709/224; 715/734

(57) ABSTRACT

Methods, apparatus, systems, and articles of manufacture directed to the monitoring and visualizing of network traffic are disclosed. The network monitoring can include tracking data packets on a per process basis. As a data packet traverses a communications interface, it can be correlated with the process responsible for that data packet and a local process address can be logged providing a record of the packet and an associated source, destination, and process identifier. The visualizing can include generating a visual representation of network traffic and packet-process correlations.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

In the fields of information technology, cybersecurity, computer networking, and/or system administration, the need to monitor per-process network traffic can be critical for security and troubleshooting purposes. This is due, at least in part, to the fact that suspicious communications patterns are one of the primary indicators of intrusions and other undesirable network activity. However, per-process monitoring of network traffic is made difficult by the design of the communications interface used by most of the modern operating systems. More specifically, common communications interfaces, which can include implementations of protocol stacks such as TCP/IP, are designed to separate the processing of network data into distinct layers. Each layer has only enough information to perform a particular function, and as data packets move through the stack, only information required by the subsequent operations in the next layer is maintained. Accordingly, for example, none of the layers simultaneously have information about both the Internet Protocol (IP) header (e.g., source and destination IP addresses) and the process responsible for a given packet.

According to one paradigm, tools for monitoring network traffic can provide network traffic data according to communication context views that include an internal host view, a networked host view, a network view, and an end-to-end view. Many of these tools are text based and do not provide visualizations of the data, which can ease the burden of analyzing large amounts of data and identifying patterns that might indicate undesirable network activity. The internal host view presents data internal to a monitored host without regard to network connections. A networked host view presents data that concerns only monitored hosts, but includes the broader context of their network connections. A network view presents traffic data in the context of a network or internetwork. An end-to-end view presents entire communications by interpreting process and communication data among a set of networked hosts in the larger context of the network or internetwork on which they reside.

A fair number of tools exist that can provide internal host views and network views. However, very few, if any, can present networked host and end-to-end views in a manner that is relevant and/or useful for security and troubleshooting purposes. Moreover, even fewer of the tools providing networked host and/or end-to-end views can correlate data packets that are entering and leaving networked hosts with the responsible processes on those hosts. Accordingly, a need exists for improved methods and apparatus for monitoring network traffic, for correlating data packets and processes, and for visualizing the network traffic and packet-process correlations.

### SUMMARY

Embodiments of the present invention include methods and apparatus for monitoring network traffic on a networked host device by tracking, on a per process basis, inbound data packets as they traverse a communications interface by correlating an inbound data packet with one or more processes responsible for the inbound data packet and by logging a local process address for the inbound data packet. Additional embodiments include visualization of network traffic between networked host devices by generating a visual representation of the networked host devices that depicts packet-process correlations for monitored networked host devices. Still other embodiments include articles of manufacture having programming configured to implement the methods and/or control the apparatus described herein.

Further still, other embodiments include network traffic monitoring systems that include one or more monitored, networked host devices having processing circuitry configured to track data packets, on a per process basis, as the data packets traverse a communications interface. Tracking of the data packets can be accomplished by correlating a data packet with one or more processes responsible for the data packet and by logging a local process address for the data packet.

A networked host device, as used herein, can refer to a computational device that is connected to a network and can execute processes that drive, or are driven by, network events. Exemplary host devices can include, but are not limited to personal computers, servers, handheld computing devices, cellular telephones, and embedded computing devices having a connection to other devices and/or a network.

In the context of tracking data packets, a “per process basis” can refer to accounting for packets and their responsible processes as the packets traverse a communications interface. For example, processes that are responsible for packets are those that either directly receive or send the packets on the network or do so indirectly via subprocesses. Typically, two processes, one on each end of the communication stream, are responsible for the packets involved. Broadcast and multicast technologies may result in multiple processes being responsible for a single packet.

The communications interface can refer to a protocol, mechanism, network stack, or processing means employed to convey data from one point to another in a network. Exemplary communications interfaces can include implementations of protocol stacks such as TCP/IP, open systems interconnection (OSI), etc.

A local process address, as used herein, can refer to packet identifying data associated with a monitored networked host device. Exemplary data can include, but is not limited to, source and/or destination IP addresses, process identifiers, executable names of responsible processes, communication socket memory addresses, and packet identifiers. In contrast to a local process address, available identifying data associated with an unmonitored, but networked, host device can be referred to as being part of a remote process address.

The monitoring of network traffic is not limited to tracking inbound data packets on a per-process basis and can include the tracking of outbound packets as they traverse the communications interface. In such embodiments, outbound data packets are correlated with one or more processes responsible for the outbound data packet and a local process address is logged for each outbound data packet.

In a variety of security and troubleshooting applications, visualization of the network traffic can provide key insight for system administrators. For example, it is often assumed that when one sees network traffic for TCP port 80, that it is web related (e.g., Hyper Text Transfer Protocol, or HTTP). However, covert or malicious actors may use any port or protocol to communicate over the network. With visual packet-process correlation, one could confirm whether the clients and servers for the aforementioned TCP port 80 traffic are indeed web browsers and/or web servers. In the context of malware, rather than running tedious system scans to locate spyware or adware, a user could simply have ambient awareness of his machine's network activities and communicating processes. In systems employing firewalls, testing for vulnerabilities becomes more complex when one or more firewalls are between a tester and the target host. It would be helpful to be able to observe the effects of traffic on the target host via visual packet-process correlation. Finally, in an example involving cluster computing, administrators who maintain large cluster computers could use visual packet-process correlation to see communicating processes in the cluster and monitor for malicious activity. In any of the examples above, visualization of packet-process correlation would benefit an administrator and/or user by complementing existing tools and enabling quicker diagnosis of problems. Even automated intrusion prevention systems could make better decisions if process names were taken into account.

Accordingly, in some embodiments of the present invention a visual representation can be generated of correlations between network traffic and processes on the monitored, networked host device. The visual representations can also broadly indicate connections between networked host devices, monitored or unmonitored. In a particular embodiment, the networked host devices are displayed as node representations. Transfers of data packets between networked host devices can be displayed as link representations connecting the relevant node representations. In one embodiment, the visual representation can be presented as a user interface and can include a connection overview histogram in addition to, or in place of, the node and link representations. The visual representations and metaphors described herein are but examples and preferred embodiments of visualizing network connections and packet-process correlations. Additional representations can be used in place of, or in addition to, those described in the instant disclosure and still fall within the scope of the invention.

In some embodiments, the local process addresses from a plurality of networked host devices, each of which has been modified and/or configured to monitor traffic according embodiments described herein, can be aggregated and used to generate a visualization depicting an end-to-end view of source and destination processes correlated with packets originating from one networked host device and destined for another.

One of the simplest approaches to correlating data packets and responsible processes (i.e., packet-process correlation) at the kernel level is by modifying the communications interface to carry process information between the network layers, thereby bridging the layer function separation described above. This approach is encompassed by the scope and the present invention, and is described elsewhere herein. However, modifying the communications interface requires that an operating system kernel be replaced with a kernel that has been modified to enable tracking, which can be unfavorable, especially for deployment at the enterprise level. Therefore, in preferred embodiments, the traffic monitoring does not require replacing the original kernel with a patched kernel that has been modified to enable the tracking. Rather, according to one particular embodiment, a loadable kernel module can be employed that uses existing structures and functions to perform packet-process correlation. Similarly, a DTrace script can be employed to eliminate the need to use a patched kernel. DTrace is a system facility in some operating systems that allows script files outside privileged, system execution space to monitor data structures within the kernel, libraries, or applications in real time. Additional approaches to capturing the data necessary to make packet-process correlations exist and may be known by those having skill in the relevant arts. Accordingly, the descriptions and embodiments disclosed herein are preferred embodiments and should not be considered limitations to the scope of the invention.

The purpose of the foregoing summary is to enable the United States Patent and Trademark Office and the public, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. The preceding and following descriptions show and describe only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### DESCRIPTION OF DRAWINGS

Embodiments of the invention are described below with reference to the following accompanying drawings.

FIG. 1 is an illustration of a communications interface depicting the separation of functions between layers.

FIG. 2 is an illustration depicting the bridging of separated functions of layers in a communications interface, according to one embodiment.

FIG. 3 is an illustration depicting the bridging of separated functions of layers in a communications interface, according to one embodiment.

FIG. 4 is an illustration depicting the bridging of separated functions of layers in a communications interface, according to one embodiment.

FIG. 5 is an illustration of a suitable architecture for making packet-process correlations, according to one embodiment.

FIG. 6 is an illustration of a system for monitoring network traffic, according to one embodiment of the present invention.

FIG. 7 is an illustration of one embodiment of a user interface for visualizing network traffic.

FIG. 8 is an illustration of a node-link visual representation of network traffic according to embodiments of the present invention.

FIG. 9 is an illustration of a overview histogram visual representation of network traffic according to embodiments of the present invention.

FIG. 10 is an illustration of an apparatus for monitoring network traffic according to embodiments of the present invention.

### DETAILED DESCRIPTION

The following description of embodiments of the present invention includes the preferred best mode. It will be clear from this description of the invention that the invention is not limited to these illustrated embodiments but that the invention also includes a variety of modifications and embodiments thereto. Therefore, the present description should be seen as illustrative and not limiting. While the invention is susceptible of various modifications and alternative constructions, it should be understood that there is no intention to limit the invention to the specific form disclosed. On the contrary, the invention is to cover all modifications, alternative constructions, and equivalents falling within the spirit and scope of the invention as defined in the claims.

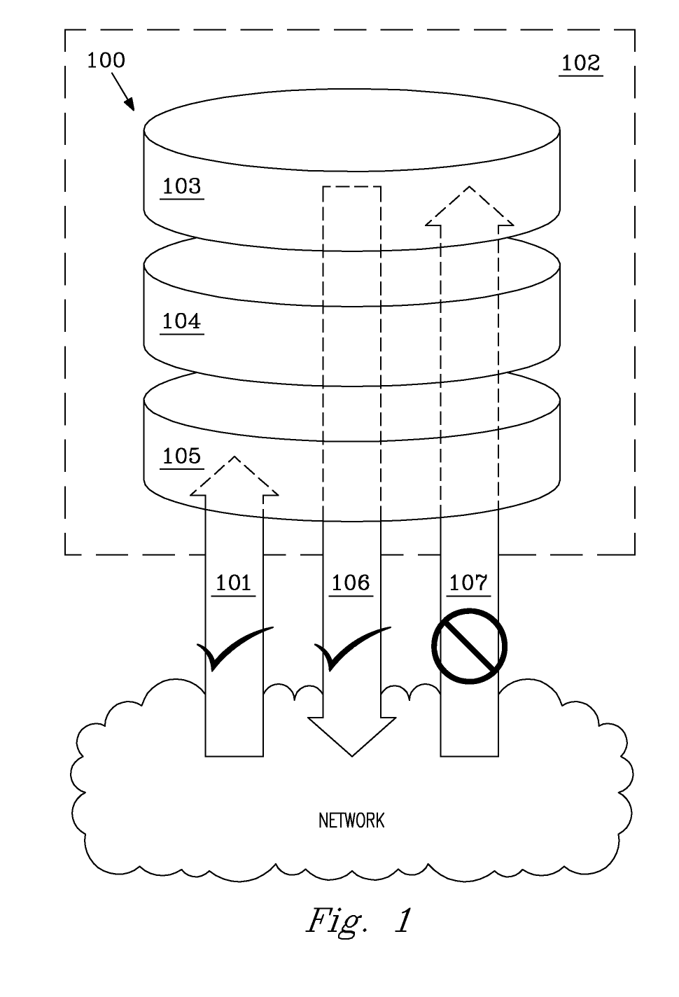

Referring to FIG. 1, which is an illustration of a communications interface 100 that can exist in a modern operating system kernel for a networked host 102, it is currently possible to trace inbound data packets into the network layer 105 and capture the IP addresses of the source and destination host devices. However, at the identifying information in the transport layer 104 is not easily accessed regarding the process to which the data packet is directed. Accordingly, it is difficult to identify the socket, and thus the process, to which the data packet is directed. There is also a lack of information regarding the source host device. Therefore in conventional communication interfaces, it is difficult, if not impossible, to trace an inbound data packet from its source host to its destination process in the application layer 103. Accordingly, in the situation illustrated in FIG. 1, it is possible to know the source host of inbound packet 101. It is also possible to know the source host, destination host, and responsible process for outbound data packet 106 because this communication originates with this host 102. However, it is not possible apart from this invention to simultaneously know both the source host and the responsible process of inbound data packet 107. There is insufficient data for correlation between the sources of data packets and the responsible processes of data packets.

Six facts are needed to make a complete end-to-end correlation of a two party communication: (1) the source IP address (SIP), (2) the destination IP address (DIP), (3) the source transport information (STI, e.g., TCP or UDP port number), (4) the destination transport information (DTI), (5) a unique process identifier on the source machine (SPI), and (6) a unique process identifier on the destination machine (DPI). Either the SPI or the DPI may be omitted if only a one-sided correlation is desired. Process identifiers (SPI and DPI) must be discovered on the source or destination machine, respectively. A process identifier may be determined by querying the transport layer 104 on the responsible machine using the STI or DTI as appropriate. Additional details are described by Glenn Fink in “Bridging the Host-Network Divide: Survey, Taxonomy, and Solution,” Proceedings of the 20th Large Installation System Administration Conference (LISA '06), Washington, D.C., pp. 247-262, USENIX, 2006, and in “Visual Correlation of Network Traffic and Host Processes for Computer Security,” Ph.D. Thesis, Virginia Polytechnic Institute and State University, 2007 both of which are incorporated herein by reference.

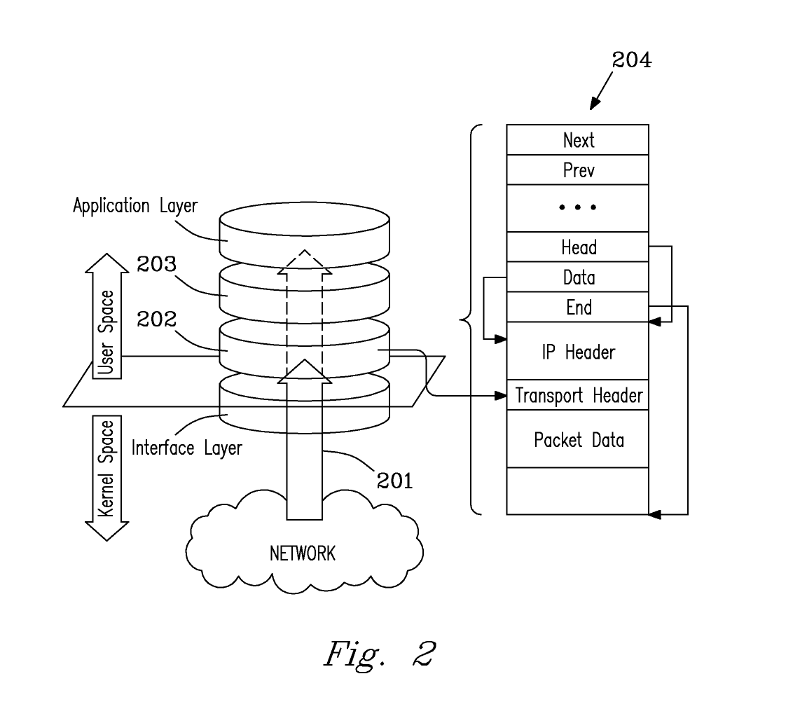

The separation of functions among each layer in the communications interface can be bridged according to embodiments of the present invention. In one such embodiment, referring to FIG. 2, the transport layer 203 can be queried for the destination socket while the inbound data packet 201 is at the network layer 202. The source host address is known in the network layer 202 and the destination socket may be retrieved by “looking forward” from the network layer into the buffer 204 which holds the transport header. The transport header contains the destination port number, which the transport layer 203 uses to find the socket address of the destination socket.

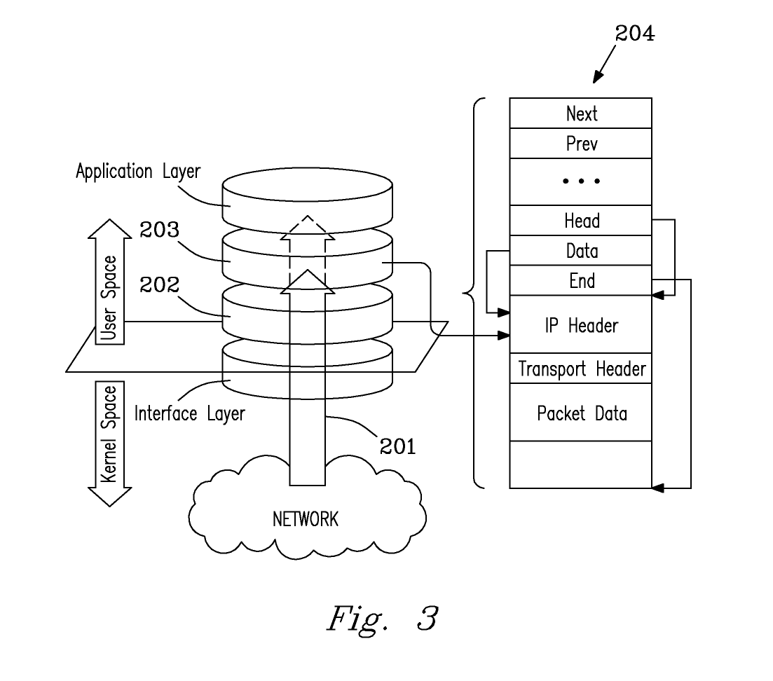

Alternatively, referring to FIG. 3, while the inbound data packet 201 is at the transport layer 203 the source host addresses can be identified by referring back to the IP header as stored in a buffer 204, which, in Linux is called an “sk_buff.” The source host address would have been written to the buffer while the inbound data packet was at the network layer 202.

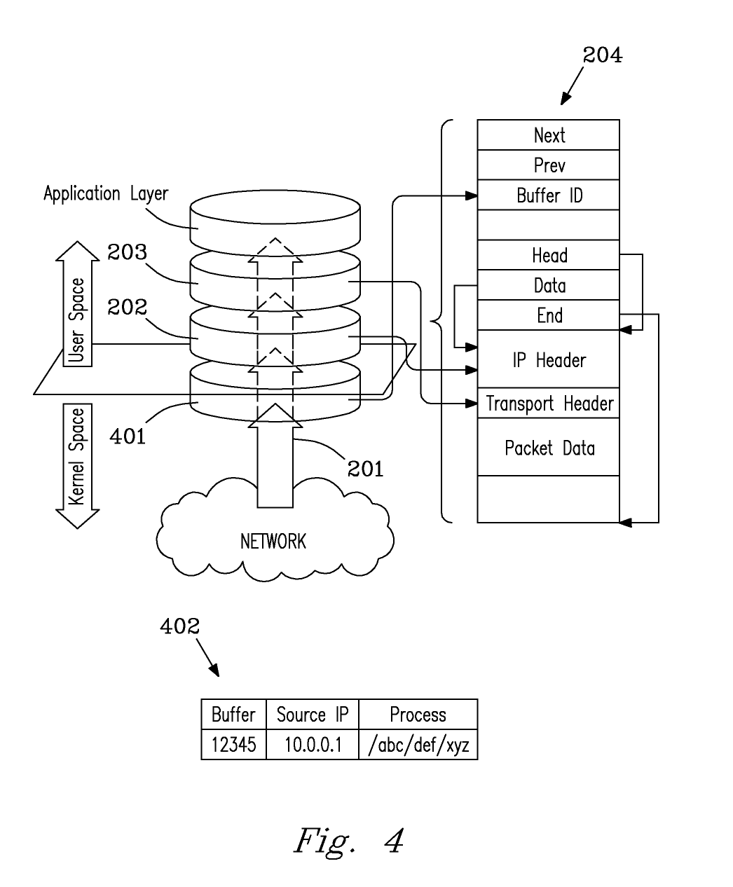

In yet another approach, referring to FIG. 4, an identifier can be generated and associated with the buffer 204 (e.g., sk_buff) that is created as an inbound data packet 201 is initially received, for example, at the interface layer 401. As the data packet traverses layers in the communications interface, data can be reported along with the appropriate buffer identifier to a connection log 402. For example, in the network layer 202 the host addresses and the buffer identifier can be reported together. Similarly, in the transport layer 203 the destination socket and the buffer identifier can be reported together. In this manner, the buffer identifier can be used to correlate the source host address and the responsible process for the inbound data packet.

Correlation of source host addresses and responsible processes for data packets can be implemented, according to one embodiment, by modifying the kernel itself to make the required packet-process correlation. The modified kernel can intercept and track each packet that belongs to a running process. The header of every packet associated with a socket as well as the name of the process that created the socket can be logged to a text file. The text file can then be processed, for instance, into an SQL database, which allows for querying and may support visualization of the data via a graphical user interface.

In one particular example, which is not intended to be a limitation in scope of the present invention, a patched Linux kernel along with a kernel module can be employed. The kernel patch can add a process identifier field to the kernel socket structure and can modify the socket creation routine to populate the field. Socket lookup functions can also be changed, or wrapped in new functions, to allow access by the module. According to the instant example, existing kernels must be replaced by the patched kernel before using the module to capture packets entering and leaving the monitored networked host device. The kernel module captures inbound and outbound packets, correlates the packets to processes using the patched process identifier field, and then logs the results to a text file.

Exemplary capture of packets entering and leaving the networked host device can be achieved using Netfilter hooks. When a kernel module is loaded, it can register handlers for Netfilter hooks for all incoming and outgoing packets. Each incoming data packet triggers the Local_In handler. If the packet is a TCP or UDP packet, the handler can copy the IP header plus the first 20 bytes of the TCP or UDP packet to a log buffer, record a high granularity timestamp (e.g., via gettimeofday( )), retrieve the process identifier of the socket owner, and queue the message for logging to a connection log file. For incoming data packets, a private TCP function is employed to bridge the separation of function that exists in the communications interface described previously. The private TCP function in the kernel retrieves a pointer to the TCP socket data structure. A reference to the sockets' responsible process is added to the socket data structure that is filled when the socket is created. Whenever the kernel module is called, a check is performed for the presence of any log records to write. Should log records exist, the records are formatted and written to a log file. The kernel module can convert the socket owner's process identifier to the filename of the process' executable making it possible for a user to identify and locate executable files that are suspect. The log records can contain a timestamp, the PID and name of the responsible process, the socket state, the packet size, and the packet header. The packet header can be converted to a hexadecimal text string so that the log file can be a text file. When the kernel module is unloaded, it can record the number of packets it processed and how many it dropped.

In an alternative embodiment, the correlation of source host addresses and responsible processes for data packets can be implemented without replacing the original kernel with a patched kernel that has been modified to enable tracking, which would eliminate the requirement to replace the existing kernel on a networked host device that is intended to be monitored. Such an embodiment can employ existing structures and functions to perform packet-process correlation and can take the form of a loadable kernel module that hooks into socket protocol callbacks to intercept socket operations. For a Linux kernel, for example, when functions such as connect( ) and recvmsg( ), are called, a callback wrapper inserts a process identifier (PID) and the memory address of the socket structure into a cache before calling the original callback. A pointer to the socket's protocol operations can then be changed to one that holds the original callbacks for all operations except release. When a socket calls the release operation, the socket address and the PID can be removed from the cache. A set of function calls can be provided for the kernel and other modules to lookup PIDs. When a lookup is requested the cache can be consulted for the given socket address and, if found, the PID of the owning process is returned. If the socket address is not contained in the cache, other search methods can be used to find the responsible process. If the socket process is not found, an appropriate result can be returned to the caller. When the module is unloaded from the kernel the original callbacks can be rewritten to the protocol operation structures into each cached socket.

While implementions for various operating systems, including Linux, Windows, Mac OS X, and UNIX, can differ slightly and can require adaptations of the examples and embodiments described herein due to underlying differences in the operating system and in the relevant communications interface, the scope of the present invention encompasses such adaptations insomuch as they are known by one having ordinary skill in the art. In one example, implementations in various operating systems can be accomplished by providing a protocol agnostic layer, wherein new protocols can be plugged in using data structures and APIs appropriate for the particular operating system.

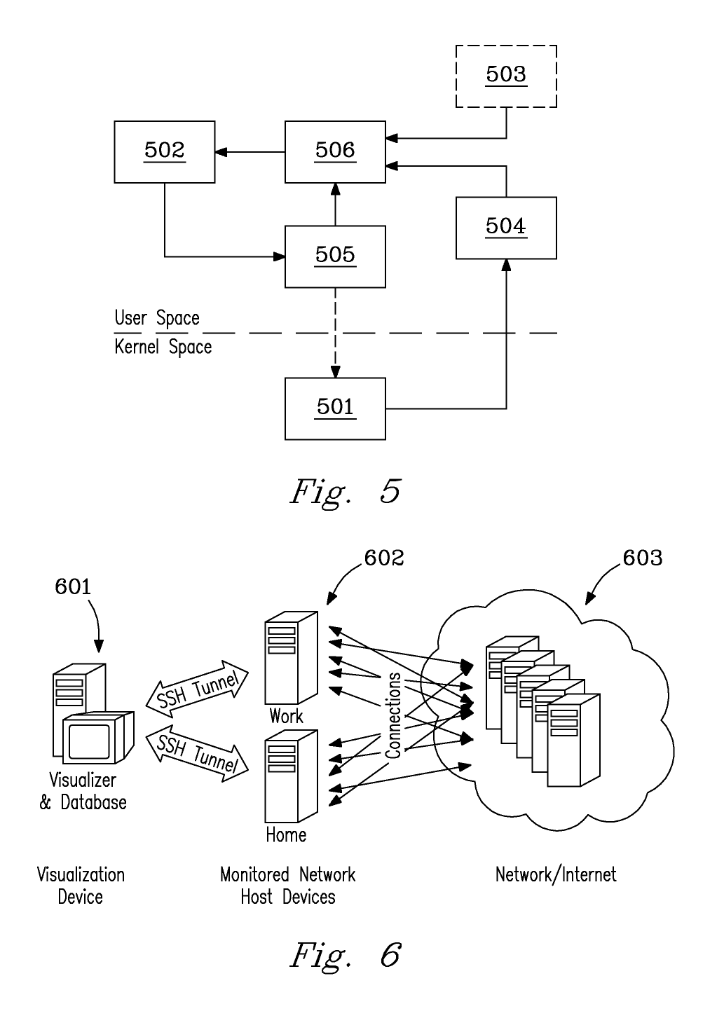

The modified kernel or the modules responsible for making packet-process correlations can record the correlations to a log. Logs from one or more monitored networked host devices can be utilized to provide communication context views such as networked host and end-to-end views. More specifically, connection data in the logs can be the basis for visual representations, which are generated to visually display connections among networked host devices. Referring to the illustration shown in FIG. 5, one embodiment of an architecture includes, a kernel that has been modified (or one that includes packet-process correlation modules as described elsewhere herein) 501, a visualizer 505, and one or more bridge processes 506. The modified kernel, or the kernel and its relevant modules, can correlate packets with responsible processes. The bridge processes can build a connection database 502 from connection logs 504 and external logs 503, which can contain source and destination IP addresses as well as packet-process correlations. The connection database 502 can contain lists of connections for every monitored host. The connections are keyed to the hosts where they are collected, the processes responsible for the packets involved, and the collected packet header data for each packet in each connection. The database supports queries in the SQL-92 query language syntax. The visualizer 505 can provide the user interface and can serve as the user's control center, loading and unloading the kernel module, and/or starting and stopping database updates.

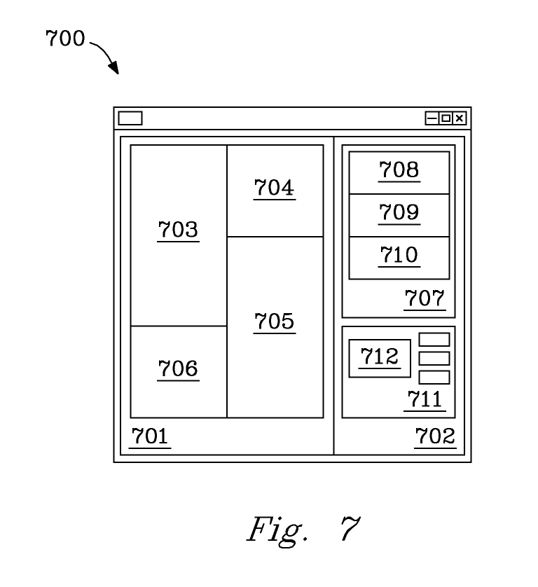

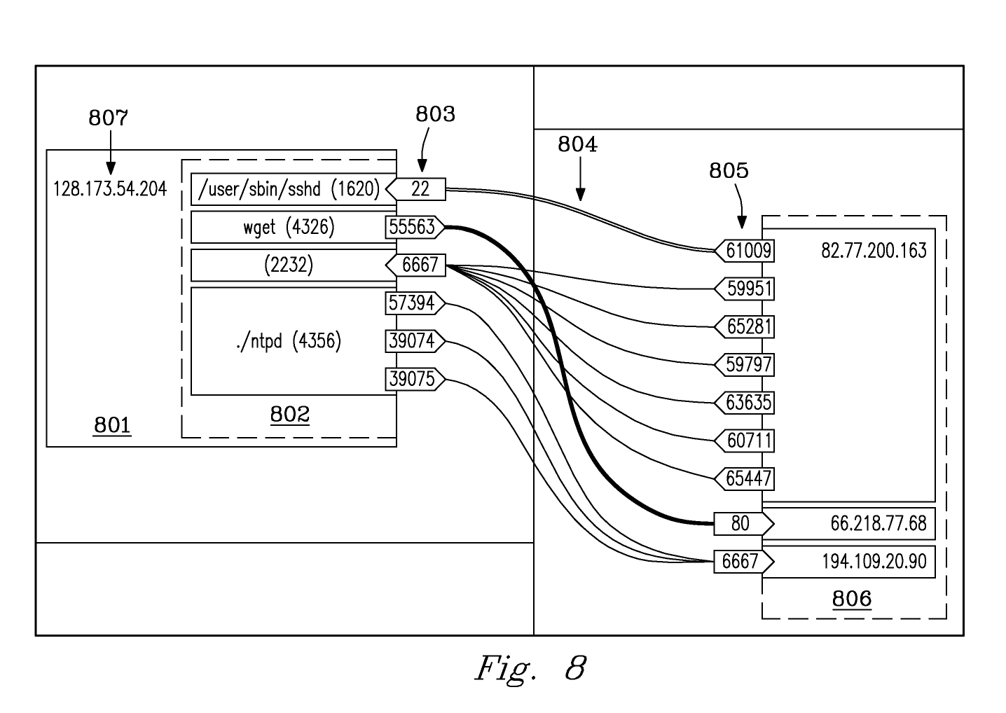

Referring to FIG. 6, an exemplary system is illustrated showing two monitored networked host devices 602 (e.g., “work” and “home”) each having connections to a network and/or the Internet 603. Each of the monitored networked host devices is also connected to a device for visualization 601, on which the connection database is stored or accessible. In the instant example, the system is able to remotely visualize data from other networked host devices because the user interface, the data collection engines, and database functions are separated into distributable components.

FIG. 7 shows a specific embodiment of a user interface for the visualizer. According to the illustration, the main window layout 700 can be divided into essentially two portions. The left portion 701 comprises the detailed view, and the right portion 702 comprises an overview and control pane. The detailed view can be subdivided into four regions, which can be characterized by the level of trust attributed to the networked host device. The four regions can include enterprise managed 703, enterprise unmanaged 706, foreign unmanaged 705, and foreign managed 704 networked host devices. In some embodiments, managed devices can be placed in the upper portion of the detailed view and enterprise devices can appear on the left portion of the detailed view. Accordingly and enterprise managed networked host device would appear in the upper left portion of the detailed view. A foreign unmanaged networked device would appear in the lower right, etc. A networked host device should be considered managed if it is running a kernel module, or a modified kernel for packet-process correlation, and is providing connection and packet-process correlation reports for logging and/or to an administrator. A networked device is called “enterprise” in this embodiment if it is owned by the enterprise (company, organization, agency, etc.) that is monitoring the communications.

The right portion of the window illustrated in FIG. 7 comprises histogram views 707 at different time scales, for example, daily 708, hourly 709, and every five minutes 710. These views can show the network traffic levels and connections using a histogram, wherein each bar represents a day, and our, or a five-minute period of time, respectively. The control pane further comprises a tabbed pane 711 with, for example, an information window 712 and a list of SQL filters.

Referring to FIG. 8, an exemplary portion of the left pane from the FIG. 7 is shown in greater detail. Each host device is depicted by IP address 807, and DNS name where known. According to its placement in the pane, the host device 801 is an enterprise monitored device. Similarly the host devices 806 are represented as foreign unmonitored devices. As a monitored device 801, the processes 802 involved in the communications can be displayed in the host icon. The process 802 can be identified by an executable name and/or a process identifier. Bristling from the inside edges of the processes or devices are the ports 803, 805 that are being utilized for communication between devices. Ports can be represented by shapes and/or graphics that indicate whether they are client or server ports. In the instant example, the port representations are shaped like arrows with listening (server) ports pointing toward their host device and initiating (client) ports pointing away from their host device. For instance, port 803 is a server port attached to an SSH service on the monitored host device, and port 805 is a client port used by an unknown process on a foreign unmonitored host having the IP address 82.77.200.163.

Communication lines 804 join client and server ports. The communication lines and icons for ports, processes, and hosts can be colored, or graphically styled, according to filtering expressions. For example, a user can elect to highlight with a “known danger” color scheme any successful incoming SSH sessions initiated on a monitored host device by a foreign unmonitored host device. Since it is feasible that thousands of events/activities can occur in any given second, the detailed view can be zoomed or shrunk in each region independently to fit onto a display device and/or present data in sufficient detail.

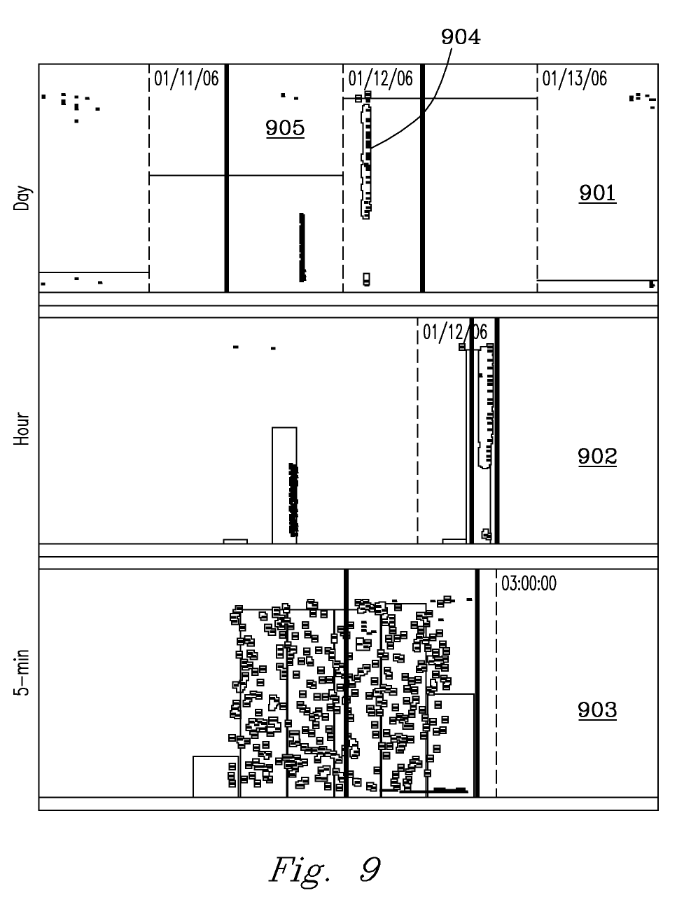

Referring to FIG. 9, the histogram views composing, in part, the control pane provide a connection overview that presents the entire database file on different scales. According to the illustrated embodiment, three different scales are provided including daily 901, hourly 902, and every 5 minutes 903. The horizontal axes of the histograms represent the passage of time from left to right, with earlier events occurring closer to the left. The relative number of connections within the time period represented by a given bar determines the height of each histogram bar. The height in pixels off the timeline can be multiplied by the number of connections within the time period of the bar and divided by the total number of connections displayed in the whole histogram to derive the line height of each bar. The uppermost histogram 901 in FIG. 9 has one bar 904 that contains most of the connections for the whole four-day period. Placing the mouse over histogram bar can show a “tool tip” window with start time of the bar and the number of connections within its duration.

An area of interest can be defined in each histogram by sliding left and right bars to bound such an area of interest. The width of the area of interest is a focal area that determines the amount of time that will be displayed in the next lower histogram. For example, in the topmost histogram 901, each bar represents one day's worth of data. As a data from a plurality of days can be presented concisely here. When the user selects an area of interest in this histogram 905, a comparable time period area is selected in the next histogram 902, wherein each bar represents one hour of data. Similarly, selecting an area of interest in the second histogram 902, results in a comparable time selection in the next histogram 903. The histograms can be overlaid with horizontal lines that represent individual connections the horizontal length of the connection line represents the duration of the connection. Because the scale may force many connection lines to zero length, lines can be constrained to be at least a length of two pixels. Longer duration connections appear nearer the bottom of the histogram. Hovering the pointer over a connection line can show a “tool tip” with the source and destination IP addresses, the relevant ports, and the measured connection duration. Users can select a connection or execute a search, and the selected or matching connections can be highlighted. The selected or matching connections will be highlighted in every view containing that connection, including the detailed and histogram views.

Referring again, to FIG. 7, the bottom portion 711 of the control pane can have a representation of tabbed windows 712. One of the tabs can present “additional information,” while another can present a list of “connection filters.” The “additional information” tab is a message box presenting detailed information on the current selection. When a user double clicks a connection line all the packets associated with that connection can be displayed in this window double-clicking a host icon can spawn a command to find information on the host's IP address. Double-clicking on a port retrieves the information from the machine's relevant file, which indicates what protocols have registered to use that port. It can also retrieve the available information about any known malicious programs using that port number to communicate. Further still, the “additional information” window can show what files the communicating process had open over its lifetime when the user double clicks its icon. The “connection filters” window can display a list of connection filters. Exemplary connection filters can be SQL expressions that the user can employ to remove extraneous display items from the detailed view, thereby showing only that which is important to the user. Filters can also omit or stylize any display item (e.g., host, process, port, and/or connection) in the detailed view using the full matching power of SQL-92 queries. Furthermore, any “filter-in” filter can be used to display any items that would have been removed by a “filter-out” filter. This allows users to filter out, for example, all Secure Shell traffic and then the filter back in traffic that comes from a particular range of IP addresses further still, users can create a filter from something that is already displayed using a query-by-example technique. Finally, users can define filters to change the display of any matching item to a predefined style. Exemplary predefined styles can include, but are not limited to, default, highlighted, safe, low-risk, medium-risk, high-risk, known danger, and unknown. The user can also change colors and fonts and lying thicknesses for each of the predefined styles as desired. Additionally, users can style individual items manually, apart from filters, to mark items of interest.

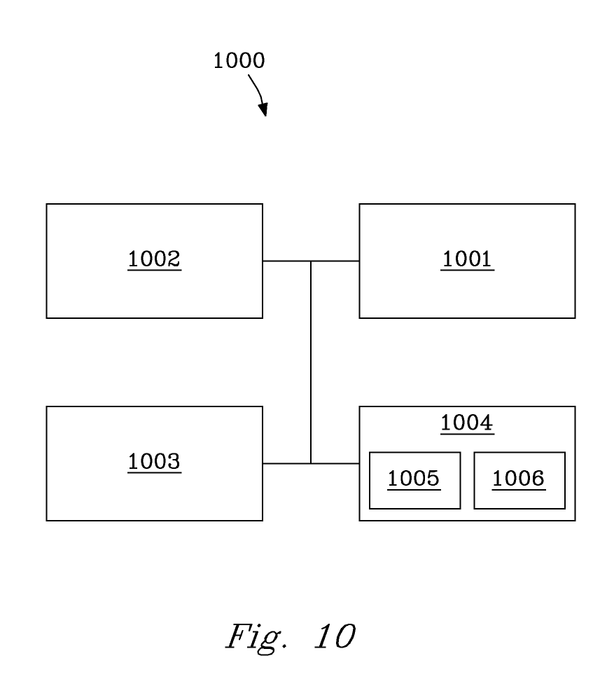

Referring to FIG. 10, an exemplary apparatus for monitoring network traffic. The apparatus comprises a networked host device that tracks data packets, on a per process basis, as the data packets traverse a communications interface of the host device. In the depicted embodiment, the apparatus 1000 is implemented as a computing device such as a work station, server, handheld computing device, or personal computer, and can include communications circuitry 1001, processing circuitry 1002, storage circuitry 1003, and, in some instances, a user interface 1004. Other embodiments of apparatus 1000 can include more, less, and/or alternative components.

The communications interface 1001 is arranged to implement communications of apparatus 1000 with respect to a network, the Internet, an external device, a remote monitoring station (e.g., a visualizer), etc. In particular, when communicating with other devices in a network, or on the Internet, communications circuitry 1001 can employ a communications interface, which can include, but is not limited to, a protocol, mechanism, network stack, or other processing means, to convey data from one point to another in a network. The communications circuitry 1001 can be implemented as a network interface card, serial connection, parallel connection, USB port, SCSI host bus adapter, FireWire interface, flash memory interface, floppy disk drive, wireless networking interface, PC card interface, PCI interface, IDE interface, SATA interface, or any other suitable arrangement for communicating with respect to apparatus 1000. Accordingly, communications circuitry 1001 can be arranged, for example, to communicate information bidirectionally with respect to apparatus 1000.

Processing circuitry 1002 is arranged to execute computer readable instructions, process data, control data access and storage, issue commands, perform calculations, and control other desired operations. Processing circuitry 1002 can operate to correlate data packets that traverse the communications interface with one or more processes responsible for the data packets and to log local process addresses for the data packets.

Processing circuitry can comprise circuitry configured to implement desired programming provided by appropriate media in at least one embodiment. For example, the processing circuitry 1002 can be implemented as one or more of a processor, and/or other structure, configured to execute computer-executable instructions including, but not limited to, software, middleware, and/or firmware instructions, and/or hardware circuitry. Exemplary embodiments of processing circuitry 1002 can include hardware logic, PGA, FPGA, ASIC, state machines, and/or other structures alone or in combination with a processor. The examples of processing circuitry described herein are for illustration and other configurations are both possible and appropriate.

Storage circuitry 1003 can be configured to store programming such as executable code or instructions (e.g., software, middleware, and/or firmware), electronic data (e.g., electronic files, databases, data items, etc.), and/or other digital information and can include, it is not limited to, processor-usable media. Exemplary programming can include, but is not limited to, programming configured to cause apparatus 1000 to monitor network traffic on a networked host device, as described elsewhere herein. Exemplary electronic data can include, but is not limited to connection logs, and/or databases, and packet-process correlation data. Processor-usable media can include, but is not limited to, any computer program product, data store, or article of manufacture that can contain, store, or maintain programming, data, and/or digital information for use by, or in connection with, an instruction execution system including the processing circuitry 1002 to in the exemplary embodiments described herein. Generally, exemplary processor-usable media can refer to electronic, magnetic, optical, electromagnetic, infrared, or semiconductor media. More specifically, examples of processor-usable media can include, but are not limited to floppy diskettes, zip disks, hard drives, random access memory, compact discs, flash memory, and digital versatile discs.

At least some embodiments or aspects described herein can be implemented using programming configured to control appropriate processing circuitry and stored within appropriate storage circuitry and/or communicated via a network or via other transmission media. For example, programming can be provided via appropriate media, which can include articles of manufacture, and/or embodied within a data signal (e.g., modulated carrier waves, data packets, digital representations, etc.) communicated via an appropriate transmission medium. Such a transmission medium can include a communication network (e.g., the Internet and/or a private network), wired electrical connection optical connection and/or electromagnetic energy, for example, via a communications interface, or provided using other appropriate communication structures or media. Exemplary programming, including processor-usable code, can be communicated as a data signal embodied in a carrier wave, in but one example.

User interface 1004 can be configured to interact with a user and/or administrator, including conveying information to the user (e.g., displaying data for observation by the user, audibly communicating data to the user, etc.) and/or receiving inputs from the user (e.g., tactile inputs, voice instructions, etc.). Exemplary information conveyed to the user can include low-level text and/or visual representations of network connections and packet-process correlations between networked host devices. Accordingly in one embodiment, the user interface 1004 can include a display device 1005 configured to depict visual information, and a keyboard, mouse, and/or other input device 1006. Examples of a display device include cathode ray tubes, plasma displays and LCDs.

The embodiment of an apparatus shown in FIG. 10 can be an integrated unit configured for monitoring network traffic by tracking, on a per process basis, data packets that traverse the apparatus' communications interface. For example, the apparatus can have a network connection to a network or to the internet, can store a connections database, and can display a visual representation of data in the connections database. Other configurations are possible, wherein apparatus 1000 is configured as a monitored networked host device and is connected to a dedicated device for visualization and storage of connection data, as described elsewhere herein.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method for monitoring network traffic on a networked host device, the method characterized by tracking, on a per process basis, inbound data packets as they traverse a communications interface by correlating an inbound data packet with one or more processes responsible for the inbound data packet and by logging a local process address for the inbound data packet, wherein the monitoring occurs without replacing an original kernel on the networked host device with one that has been modified to enable the tracking.

2. The method of claim 1, wherein the monitoring occurs by employing a loadable kernel module, a DTrace script, or a combination thereof.

3. The method of claim 1, further comprising tracking, on a per process basis, outbound data packets as they traverse a communications interface by correlating an outbound data packet with one or more processes responsible for the outbound data packet and by logging a local process address for the outbound data packet.

4. The method of claim 1, wherein correlating inbound data packets with the processes responsible for the data packets comprises:
identifying correlations between sockets and processes;
examining an inbound data packet as it traverses the network layer of a communications interface to identify one or more destination sockets to which the inbound data packet is directed; and
determining one or more responsible processes correlated with the destination sockets for the inbound data packet;
wherein the destination sockets and executables of the responsible processes are logged as at least a portion of the local process address for the inbound data packet.

5. The method of claim 1, wherein correlating inbound data packets with the processes responsible for the data packets comprises:
identifying correlations between sockets and processes;
examining an inbound data packet as it traverses the transport layer of a communications interface to identify host addresses for the inbound data packet; and
identifying one or more destination sockets for the inbound data packet at the transport layer of the networking stack; and
determining one or more responsible processes correlated with the destination sockets for the inbound data packet;
wherein the host addresses, the destination sockets, and executables of the responsible processes are logged as at least a portion of the local process address for the inbound data packet.

6. The method of claim 1, wherein correlating inbound data packets with the processes responsible for the data packets comprises:
identifying correlations between sockets and processes;
generating an identifier for an inbound data packet;
identifying host addresses for an inbound data packet as it traverses the network layer of a communications interface and associating the host addresses with the identifier;
identifying one or more destination sockets for the inbound data packet as it traverses the transport layer of the communications interface and associating the destination sockets with the identifier; and
determining one or more responsible processes correlated with the destination sockets for the inbound data packet;
wherein the identifier, the destination sockets, executables of the responsible processes, and the host addresses are logged as at least a portion of the local process address for the inbound data packet.

7. The method of claim 1, further comprising generating a visual representation of correlations between processes on the networked host device and network traffic.

8. The method of claim 1, further comprising aggregating the local process addresses from a plurality of networked host devices and generating from the aggregated local process addresses a visualization depicting an end-to-end view of source and destination processes correlated with packets originating from one networked host device and destined for another.

9. The method of claim 1, wherein the communications interface comprises an implementation of a protocol stack.

10. The method of claim 1, wherein the communications interface comprises the TCP/IP protocol suite.

11. The method of claim 1, wherein the local process address comprises data identifying at least a source networked device, a destination networked device, and a responsible process on the destination networked device.

12. A network traffic monitoring system comprising at least one monitored networked host device having processing circuitry configured to track, on a per process basis, inbound data packets as they traverse a communications interface by correlating an inbound data packet with one or more processes responsible for the inbound data packet and by logging a local process address for the inbound data packet, wherein original kernels on the monitored networked host devices are not replaced with kernels that have been modified to enable the monitored network host devices to track the inbound data packets.

13. The network traffic monitoring system of claim 12, further comprising a visualization device connected to at least one monitored networked host device and, optionally, one or more unmonitored, networked host devices, the visualization device comprising processing circuitry configured to aggregate local and remote process addresses from the monitored and unmonitored networked host devices, respectively, and to generate a visualization depicting:
source and destination addresses for network traffic between networked host devices; and
packet-process correlations for network traffic received by or sent from monitored, networked host devices.

14. The network traffic monitoring system of claim 13, wherein the visualization based on aggregated local process addresses, depicts an end-to-end view of source and destination processes correlated with packets originating from one monitored networked host device and destined for another.

15. The network traffic monitoring system of claim 12, wherein the monitored networked host devices employ a loadable kernel module, a DTrace script, or a combination thereof to perform the tracking.

16. The network traffic monitoring apparatus of claim 12, wherein the communications interface comprises an implementation of a protocol stack.

17. The network traffic monitoring apparatus of claim 12, wherein the communications interface comprises the TCP/IP protocol suite.

18. The network traffic monitoring apparatus of claim 12, wherein the local process address comprises data identifying at least a source networked device, a destination networked device, and a responsible process on the destination networked device.

19. A method of visualizing network traffic between networked host devices, wherein at least one of the networked host devices is a monitored networked host device configured to log local process addresses without replacing original kernels on the monitored networked host devices with kernels that have been modified to enable the monitored networked host devices to track inbound data packets, the method comprising generating a visual representation of the networked host devices that depicts packet-process correlations for the monitored networked host devices.

20. A method of visualizing on a display device network traffic between a plurality of networked host devices comprising:
displaying node representations of networked host devices that contribute to the network traffic during a period of time; and
displaying link representations of data packet transfers between networked host devices;
wherein the node representations provide host identifiers for each of the networked host devices and the node representations provide process identifiers for processes correlated with data packets received by or sent from monitored, networked host devices, and wherein original kernels on the monitored networked host devices are not replaced with ones that have been modified to enable the monitored, networked host devices to track inbound data packets.

21. The method of claim 20, wherein ports on networked host devices used for transferring the data packets are identified by port representations at the terminal ends of the link representations.

22. The method of claim 21, wherein port representations are shaped to indicate whether they are client or server ports.

23. The method of claim 20, wherein coloring can be applied manually, or according to a filter expression, to node representations, link representations, port representations, process identifiers, host identifiers, or combinations thereof

24. A method of visualizing on a display device network traffic between a plurality of networked host devices comprising, displaying a connection overview histogram depicting the total number of connections as a function of time for at least one given time scale, wherein original kernels on monitored networked host devices are not replaced with ones that have been modified to enable the monitored networked host devices to track inbound data packets on a per process basis.

25. A user interface for a network traffic monitoring system in which a plurality of packet-process correlations and connections between networked host devices have been logged, wherein each of the packet-process correlations and the connections is indicated on a display in the form of node and link representations, connection overview histograms, or both, and wherein original kernels on monitored networked host devices are not replaced with ones that have been modified to enable the monitored networked host devices to track inbound data packets on a per process basis.

26. An article of manufacture comprising computer-readable media having programming configured to control processing circuitry to implement processing comprising tracking, on a per process basis, inbound data packets as they traverse a communications interface by correlating an inbound data packet with one or more processes responsible for the inbound data packet and by logging a local process address for the inbound data packet, wherein the programming does not cause the replacement of an original kernel with one that has been modified to enable the tracking.

27. An article of manufacture comprising computer-readable media having programming configured to control processing circuitry to implement processing comprising visualizing on a display device a plurality of connections and packet-process correlations between networked host devices, wherein the programming does not cause the replacement of an original kernel with one that has been modified to enable the packet-process correlations.

28. The article of manufacture of claim 27, wherein each of the packet-process correlations and the connections is indicated on a display in the form of node and link representations, connection overview histograms, or both.
